(19) United States
(12) Patent Application Publication
(10) Pub. No.: US 2022/0352987 A1
(43) Pub. Date: Nov. 3, 2022

(54) OPTICAL TRANSMITTER DEVICE, OPTICAL TRANSMISSION DEVICE, AND OPTIMUM-PHASE-AMOUNT CALCULATION METHOD

(71) Applicant: FUJITSU OPTICAL COMPONENTS LIMITED, Kawasaki-shi (JP)

(72) Inventor: Masakazu HORISHITA, Kawasaki (JP)

(73) Assignee: FUJITSU OPTICAL COMPONENTS LIMITED, Kawasaki-shi (JP)

(21) Appl. No.: 17/670,108

(22) Filed: Feb. 11, 2022

(30) Foreign Application Priority Data
Apr. 30, 2021 (JP) 2021-077692

(51) Int. Cl. H04B 10/548; H04B 10/079

(52) U.S. Cl. CPC H04B 10/548; H04B 10/0795

(57) ABSTRACT

An optical transmitter device includes a modulator of the Mach-Zehnder type that modulates the optical signal from an emitter and outputs modulated signals; and a phase controller that controls the phase difference of the modulator according to a setting phase amount. The device includes a controller, a sweeper, and an estimator. The controller controls the bias current of the emitter so that the power of the modulated signals detected at the output stage of the modulator during the optical shutdown becomes the target value during the optical shutdown. After the bias current is controlled, the sweeper performs constant-period sweeping of the phase of the modulator. The estimator estimates, while sweeping the phase, the transmission characteristics of the modulator from the power of the optical signal detected at the input stage of the modulator; and, from the estimated characteristics, calculates the optimum phase amount to be set in the phase controller.

### CROSS-REFERENCE TO RELATED APPLICATION

This application is based upon and claims the benefit of priority of the prior Japanese Patent Application No. 2021-077692, filed on Apr. 30, 2021, the entire contents of which are incorporated herein by reference.

### FIELD

The embodiment discussed herein is related to a optical transmitter device, an optical transmission device, and an optimum-phase-amount calculation method.

### BACKGROUND

In recent years, as far as an optical transmitter device is concerned, for example, a Mach-Zehnder modulator (MZM) is known in which a Mach-Zehnder interferometer (MZI) is used and optical signal having continuous waves (CW) are modulated using data signals of electrical signals. In an MZM, electrical signals are applied onto the electrodes that are disposed on the arms placed parallel to each other. As a result, there occurs a change in the optical refraction indexes on the arms, and a phase difference occurs between the optical signals that follow the arms. Then, optical modulation is performed by multiplexing the optical signals having a phase difference therebetween.

However, in an MZM, the phase difference needs to be retained at the midpoint of the MZM transmittance (i.e., at the optimum phase amount). However, for example, due to age deterioration or temperature fluctuation, the MZM transmission characteristics undergo fluctuation thereby causing a shift in the optimum phase amount. Hence, factually, there is a demand for a control unit for retaining the optimum phase difference on a constant basis.

In that regard, as a method for controlling the optimum phase amount of the MZM, for example, dither signals of low-frequency sinusoidal modulation are superimposed on the main signals (such as NRZ signals (NRZ stands for Non Return to Zero)). Moreover, a technique is commonly known by which, in the average optical output power coming from the MZM, the bias voltage is controlled in such a way that the dither signal frequency component is suppressed. Thus, in an optical transmitter device in which an MZM is used, when control is performed to achieve the optimum phase difference of the MZM, the dither frequency component gets eliminated at the average value of the optical output power.
[Patent Literature 1] Japanese Laid-open Patent

Publication No. 2002-23119
[Patent Literature 2] Japanese Laid-open Patent Publication No. 2009-80189

However, in an optical transmitter device in which an MZM is used, if there is a shift in the optimum phase amount of the MZM, the dither frequency component remains present. Hence, the optical output power fluctuates due to the impact of the dither signals, and the transmission quality of the main signals deteriorates due to waveform distortion of the optical output power.

### SUMMARY

According to an aspect of an embodiment, an optical transmitter device includes an optical emitter, an optical modulator of Mach-Zehnder type, a first optical monitor, a second optical monitor, a phase controller, a controller, a phase sweeper and an estimator. The optical emitter emits an optical signal according to bias current. The optical modulator modulates the optical signal using an electrical signal and outputs an optical-modulated signal. The first optical monitor detects power of the optical signal at input stage of the optical modulator. The second optical monitor detects power of the optical modulated signal at output stage of the optical modulator. The phase controller controls phase difference of the optical modulator according to a setting phase amount. The controller detects power of the optical modulated signal using the second optical monitor, during optical shutdown of the optical transmitter device, and controls bias current of the optical emitter in such a way that detection result obtained by the second optical monitor becomes target value during optical shutdown. The phase sweeper performs constant-period sweeping of phase of the optical modulator after bias current of the optical emitter is controlled by the controller. The estimator detects power of the optical signal using the first optical monitor while performing constant-period sweeping of phase of the optical modulator. The estimator estimates transmission characteristic of the optical modulator from detection result obtained by the first optical monitor. The estimator calculates optimum phase amount to be set in the phase controller, from estimation result of the transmission characteristic.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of an optical transmission device according to an embodiment;

FIG. 2 is a block diagram illustrating an exemplary configuration of an optical transmitter device;

FIG. 3 is an explanatory diagram illustrating an example of the bias current control based on a second-type monitoring value in the optical shutdown state;

FIG. 4 is an explanatory diagram illustrating an example of an estimation operation for estimating the transmission characteristics of an MZM in the optical shutdown state;

FIG. 5 is an explanatory diagram illustrating an example of the bias current control based on the second-type monitoring value at the time of phase fluctuation in the optical shutdown state;

FIG. 6 is an explanatory diagram illustrating an example of the estimation operation for estimating the transmission characteristics of the MZM at the time of phase fluctuation in the optical shutdown state;

FIGS. 7A and 7B are flowcharts for explaining an example of the operations performed by the optical transmitter device for stabilization;

FIG. 8 is a block diagram illustrating an example of an optical transmitter device according to a first comparison example;

FIG. 9 is an explanatory diagram illustrating an example of the characteristics of the optical power versus the phase delay amount of the optical-modulated signals before and after the phase fluctuation during the operations in the optical transmitter device according to the first comparison example;

FIG. 10 is an explanatory diagram illustrating an example of the characteristics of the optical power versus the phase delay amount of the optical-modulated signals before and after the phase fluctuation at the time of cancelling the optical shutdown in the optical transmitter device according to the first comparison example;

FIG. 11 is an explanatory diagram illustrating an example of the fluctuation transition of the optical power of the optical-modulated signals in the optical transmitter device according to the first comparison example;

FIG. 12 is a block diagram illustrating an example of an optical transmitter device according to a second comparison example; and

FIG. 13 is a diagram illustrating an example of the fluctuation transition of the output of the optical transmitter device according to the second comparison example.

### DESCRIPTION OF EMBODIMENT

Preferred embodiments of the present invention will be explained with reference to accompanying drawings. However, the disclosed technology is not limited by the embodiment. Moreover, embodiments can be appropriately combined without causing any contradictions.

### First Comparison Example

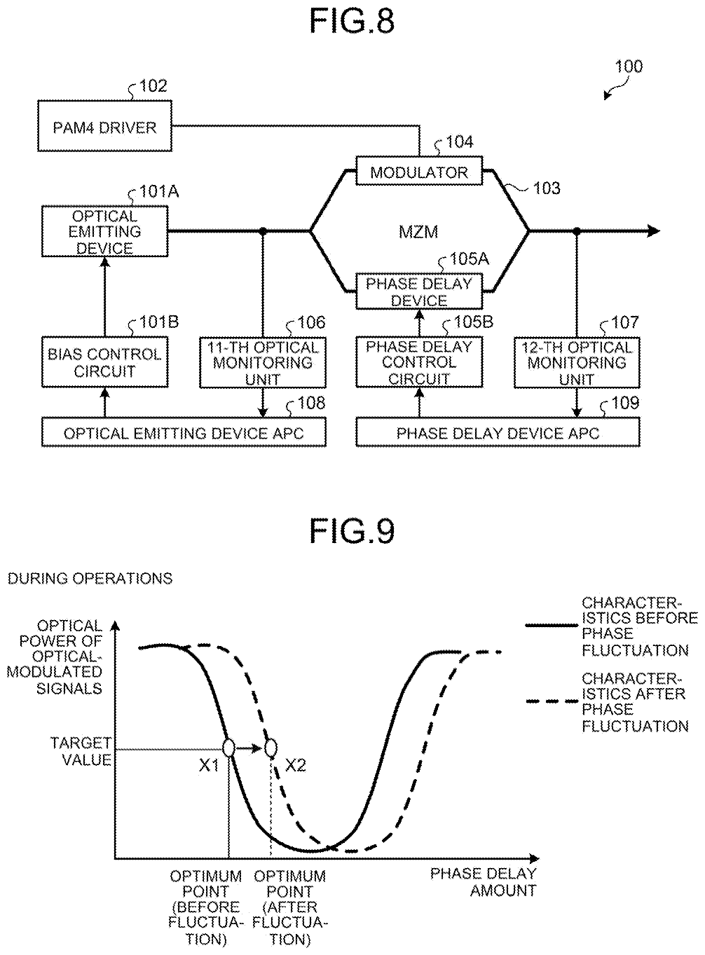

FIG. 8 is a block diagram illustrating an example of an optical transmitter device 100 according to a first comparison example. In the optical transmitter device 100 illustrated in FIG. 8, in order to ensure that the optical power at the output stage of an MZM 103 is stabilized without using dither signals, the optimum phase amount corresponding to the optimum bias point of the MZM 103 (the phase delay amount of the MZM 103) is controlled.

The optical transmitter device 100 includes a optical emitting device 101A, a PAM4 driver 102 (PAM4 stands for Pulse Amplitude Modulation 4), and the MZM 103. The MZM 103 includes a modulator 104 disposed on one of the arms, and a phase delay device 105A disposed on the other arm. Moreover, the optical transmitter device 100 includes a bias control circuit 101B, a phase delay control circuit 105B, an 11-th optical monitoring unit 106, a 12-th optical monitoring unit 107, a optical emitting device APC 108 (APC stands for Auto Power Control), and a phase delay device APC 109.

The optical emitting device 101A emits an optical signal having continuous waves (CW) according to the bias voltage, and varies the output level of the optical signal according to the amount of the bias current. The PAM4 driver 102 inputs, for example, the electrical signals of the PAM4 to the modulator 104 of the MZM 103. Meanwhile, the PAM4 represents, for example, multivalued electrical signals having the levels from 0 to 3. The modulator 104 performs optical modulation of the optical signal coming from the optical emitting device 101A according to the electrical signals of the PAM4.

The phase delay device 105A of the MZM 103 is configured with, for example, a heater for performing delay adjustment of the phase of the MZM 103. In the MZM 103, when the electrical signals of the PAM4 are applied to the electrodes on the arms that are disposed parallel to each other, the optical refractive index of the arms changes and there occurs a phase difference in the optical signals that follow the arms. Then, the MZM 103 multiplexes the optical signals having a phase difference and outputs optical-modulated signals.

The 11-th optical monitoring unit 106 detects the optical power of the optical signal passing through the input stage of the MZM 103. The 12-th optical monitoring unit 107 detects the optical power of the optical-modulated signals passing through the output stage of the MZM 103. The bias control circuit 101B controls the bias current that is supplied to the optical emitting device 101A. The phase delay control circuit 105B controls the phase delay device 105 of the MZM 103 according to the phase delay amount.

The optical emitting device APC 108 controls the bias control circuit 101B in such a way that the optical power of the optical signal at the input stage of the MZM 103, which is detected by the 11-th optical monitoring unit 106, remains constant. The phase delay device APC 109 controls the phase delay control circuit 105B in such a way that the optical power of the optical-modulated signals at the output stage of the MZM 103, which is detected by the 12-th optical monitoring unit 107, remains constant.

In the optical transmitter device 100, after the optical emitting device APC 108 is used for adjusting the bias current to ensure that the optical power at the input stage of the MZM 103 remains constant, the phase delay device APC 109 is used for adjusting the phase delay amount of the MZM 103 to ensure that the optical power at the output stage of the MZM 103 remains constant.

FIG. 9 is an explanatory diagram illustrating an example of the characteristics of the optical power versus the phase delay amount of the optical-modulated signals before and after the phase fluctuation during the operations in the optical transmitter device 100 according to the first comparison example. For example, in the MZM 103, the phase undergoes fluctuation due to temperature variation or temporal variation. In the characteristics of the optical power versus the phase delay amount of the optical-modulated signals before the phase fluctuation (as illustrated by a solid line), X1 represents the optimum phase amount that is the target value for the optical power of the optical-modulated signals, and it is assumed that the operations are carried out at with the phase delay amount (the pre-fluctuation optimum point) corresponding to the optimum phase amount. If there is fluctuation in the phase during the operations due to temperature variation; then, in the characteristics of the optical power versus the phase delay amount of the optical-modulated signals after the phase fluctuation (as illustrated by a dotted line), in order to ensure that the optimum phase amount follows from X1 to X2 in such a way that the optical power of the optical-modulated signals maintains the target value, the adjustment needs to be done to match the phase delay amount (the post-fluctuation optimum point) corresponding to the optimum phase amount X2. As a result, during the operations, the phase delay amount (the optimum point) equivalent to the optimum phase amount can be retained in such a way that the optical power of the optical-modulated signals becomes the target value.

In the optical transmitter device 100 according to the first comparison example, since the dither signals are not used, there is no impact of the dither signals and the main signals are also not affected as pointed out in the issue faced in the conventional technology.

However, in the optical transmitter device 100 according to the first comparison example, for example, at the time of switching from the operation line for transmitting optical signals to another line, sometimes optical shutdown (SD) is performed so that the output of the optical-modulated signals is temporarily blocked. For example, if the optimum phase amount X1 present immediately before the optical shutdown is different than the optimum phase amount X2 present at the time of cancelling the optical shutdown, then there is a need to have a mechanism for following from the optimum phase amount X1 present immediately before the optical shutdown to the optimum phase amount X2 present at the time of cancelling the optical shutdown.

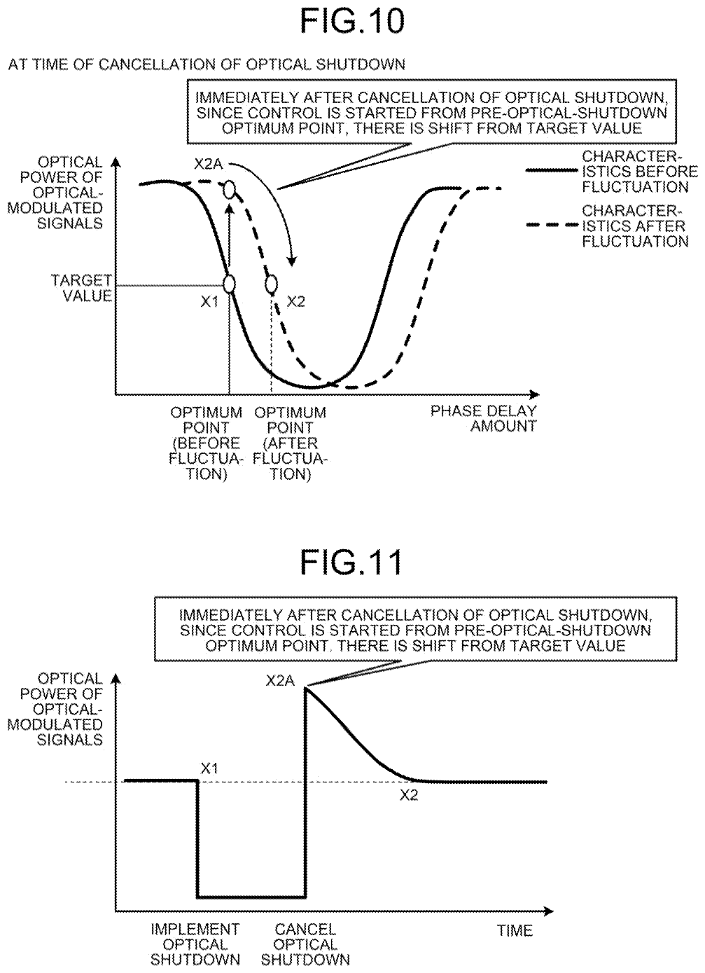

FIG. 10 is an explanatory diagram illustrating an example of the characteristics of the optical power versus the phase delay amount of the optical-modulated signals before and after the phase fluctuation at the time of cancelling the optical shutdown in the optical transmitter device 100 according to the first comparison example. FIG. 11 is an explanatory diagram illustrating an example of the fluctuation transition of the optical power of the optical-modulated signals in the optical transmitter device 100 according to the first comparison example. In the operating state illustrated in FIG. 9 (i.e., in the state in which optical emission is going on), even if there is phase fluctuation, the phase delay device APC 109 can be used to follow the optimum phase amount in such a way that the optical power of the optical-modulated signals becomes the target value. However, at the time of cancelling the optical shutdown as illustrated in FIG. 10, the control is started from the phase delay amount that is equivalent to the optimum phase amount X1 of the pre-phase-fluctuation characteristics (as illustrated by a solid line) present immediately before the optical shutdown. Then, the phase delay amount is varied to be equal to the optimum phase amount X2 of the post-phase-fluctuation characteristics (as illustrated by a dotted line), so that the optical power of the optical-modulated signals becomes the target value. However, after the cancellation of the optical shutdown, the control is started from the phase delay amount (the pre-fluctuation optimum point) that is equivalent to an optimum phase amount X2A of the post-fluctuation characteristics (as illustrated by a dotted line) equivalent to the phase delay amount of the optimum phase amount X1 of the pre-fluctuation characteristics. For that reason, there arises a period of time in which the optical power of the optical-modulated signals deviates from the target value. That is, after the cancellation of the optical shutdown, in the period of time in which the optical power of the optical-modulated signals deviates from the target value, the transmission quality of the main signals deteriorates due to waveform collapsing and optical power fluctuation.

In that regard, as a method for avoiding the output of the main signals having deteriorated transmission quality immediately after the cancellation of the optical shutdown, it is possible to think of an optical transmitter device 100A according to a second comparison example in which a optical blocking unit 110 is disposed at the output stage of the MZM 103 for the purpose of blocking the output of the optical-modulated signals.

### Second Comparison Example

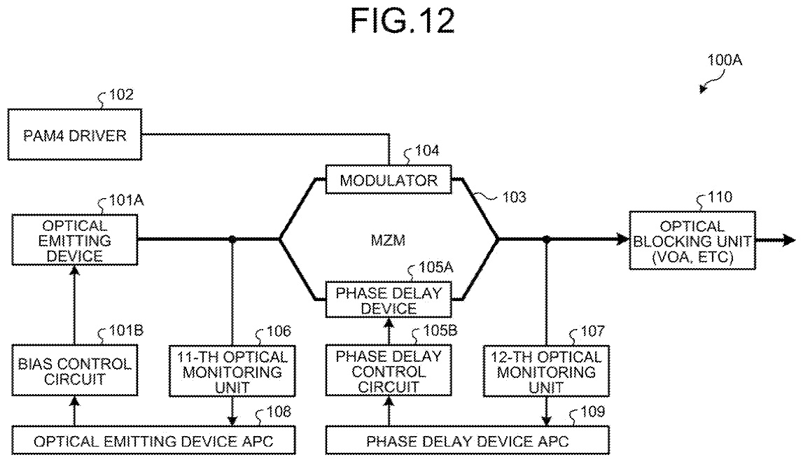

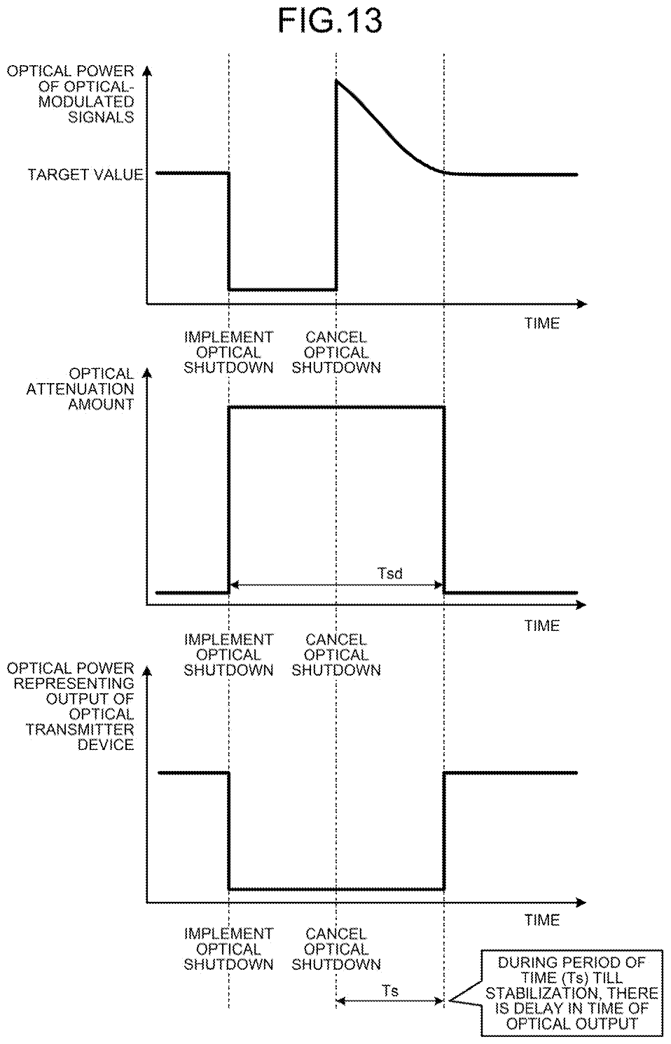

FIG. 12 is a block diagram illustrating an example of the optical transmitter device 100A according to the second comparison example. FIG. 13 is a diagram illustrating an example of the fluctuation transition of the output of the optical transmitter device 100A according to the second comparison example. Herein, the identical configuration to the optical transmitter device 100 according to the first comparison example illustrated in FIG. 8 is referred to with the same reference numerals, and the explanation of such identical configuration and operations is not given again. In the optical transmitter device 100A illustrated in FIG. 12, the optical blocking unit 110 is disposed at the output stage of the MZM 103. The optical blocking unit 110 blocks the output of the MZM 103 during a time period Tsd starting from the time of execution of the optical shutdown to the time at which the optical power of the optical-modulated signals after the cancellation of the optical shutdown reaches the optimum phase amount of the post-phase-fluctuation characteristics so as to become equal to the target value. That is, in the optical transmitter device 100A, as illustrated in FIG. 13, during the time period Tsd starting from the time of execution of the optical shutdown to the time at which the optical power of the optical-modulated signals after the cancellation of the optical shutdown reaches the optimum phase amount of the post-phase-fluctuation characteristics so as to become equal to the target value, the output of the optical-modulated signals is blocked.

However, in the optical transmitter device 100A according to the second comparison example, a time period Ts needs to be secured that starts from the time of cancellation of the optical shutdown to the time at which the optical power of the optical-modulated signals reaches the target value, and it is possible to think of a case in which the period of time from cancelling the optical shutdown to outputting the optical-modulated signals cannot conform to the decided specification criteria.

Moreover, for example, in a 400G optical transmission device with a built-in optical transmitter device having 100G×4ch applications, it is not possible to perform optical emission/optical extinction (optical shutdown) in only arbitrary channels from among the four channels, and the specification is such that all channels are subjected to optical emission/optical extinction at once. In that regard, regarding an optical transmitter device for wavelength-multiplexed optical signal in which an MZM of an asymmetrical Mach-Zehnder interferometer is used, there is a demand for an optical transmission device with a built-in optical transmitter device that need not superimpose dither signals and is capable of starting from the phase delay amount of the optimum phase amount even at the time of cancelling the optical shutdown. In that regard, the following explanation is given about an optical transmission device according to the embodiment.

### Embodiment

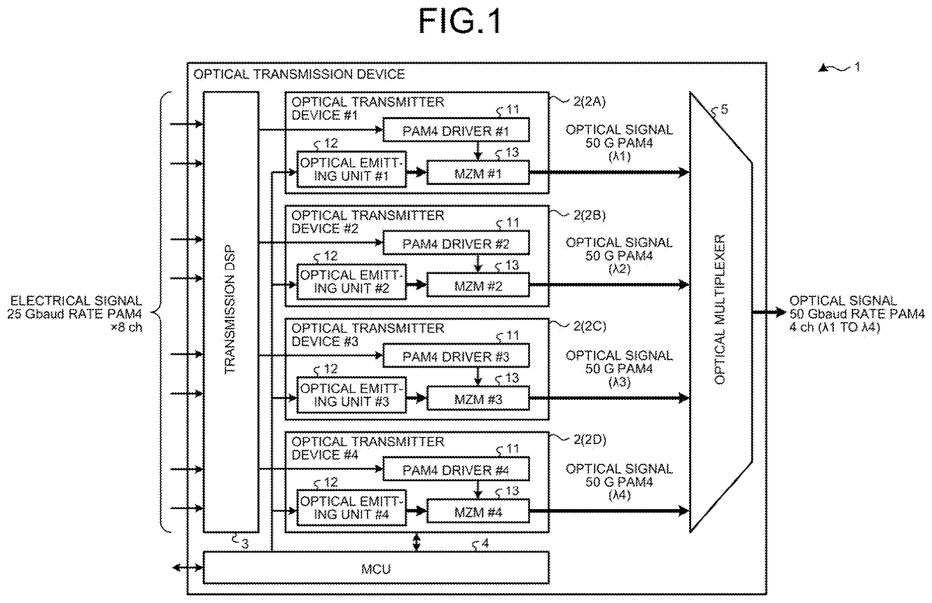

FIG. 1 is an explanatory diagram illustrating an example of an optical transmission device 1 according to the embodiment. The optical transmission device 1 illustrated in FIG. 1 is, for example, a 400G optical transmission device in which pulse amplitude modulation 4 (PAM4) is used. In the optical transmission device 1, the PAM4 signals are four-valued signals. Hence, even when eight lanes of 25 Gbaud rate PAM4 signals are used for the input of electrical signals, it becomes possible to input quasi electrical signals of 400 Gbps. In the optical transmission device 1, regarding the input of optical signals, PAM4 modulation of 50 Gbaud rate is performed with respect to a single optical wavelength, and four wavelengths λ1 to λ4 are used so as to perform optical transmission of 400 Gbps. Then, in the optical transmission device 1, the optical-modulated signals of each wavelength of each optical transmitter device 2 are multiplexed, and a wavelength-multiplexed optical signal representing the post-multiplexing optical-modulated signals is output from a single optical fiber.

The optical transmission device 1 includes four optical transmitter devices 2 (#1 to #4), a transmission DSP 3 (DSP stands for Digital Signal Processor), a micro control unit (MCU) 4, and an optical multiplexer 5. The transmission DSP 3 receives input of eight channels of 25 Gbaud rate PAM4 signals, and converts them into four channels of 50 Gbaud rate PAM4 signals. Then, the transmission DSP 3 inputs the 50 Gbaud rage PAM4 signals in the units of channels to a PAM4 driver 11 of each optical transmitter device 2. The MCU 4 controls the entire optical transmission device 1. The MCU 4 controls a optical emitting unit 12 of each optical transmitter device 2.

An optical transmitter device 2A (2) (the optical transmitter device #1) performs optical modulation of the optical signal having the wavelength λ1 with PAM4 signals, and outputs the optical-modulated signals having the wavelength λ1 to the optical multiplexer 5. An optical transmitter device 2B (2) (the optical transmitter device #2) performs optical modulation of the optical signal having the wavelength λ2 with PAM4 signals, and outputs the optical-modulated signals having the wavelength λ2 to the optical multiplexer 5. An optical transmitter device 2C (2) (the optical transmitter device #3) performs optical modulation of the optical signal having the wavelength λ3 with PAM4 signals, and outputs the optical-modulated signals having the wavelength λ3 to the optical multiplexer 5. An optical transmitter device 2D (2) (the optical transmitter device #4) performs optical modulation of the optical signal having the wavelength λ4 with PAM4 signals, and outputs the optical-modulated signals having the wavelength λ4 to the optical multiplexer 5. Then, the optical multiplexer 5 multiplexes the optical-modulated signals having the wavelengths λ1 to λ4 as received from the optical transmitter devices 2 (#1 to #4), and outputs post-multiplexing wavelength-multiplexing signals.

Each optical transmitter device 2 includes the PAM4 driver 11, the optical emitting unit 12, and an MZM 13. The PAM4 driver 11 applies PAM4 signals, which are electrical signals corresponding to the 50 Gbaud rate PAM4 signals received from the transmission DSP 3, to a modulator 13A of the MZM 13. The optical emitting unit 12 emits the optical signal having continuous waves (CW) that is to be input to the MZM 13. The MZM 13 modulates the optical signal, which is received from the optical emitting unit 12, according to the PAM4 signals received from the PAM4 driver 11, and outputs optical-modulated signals.

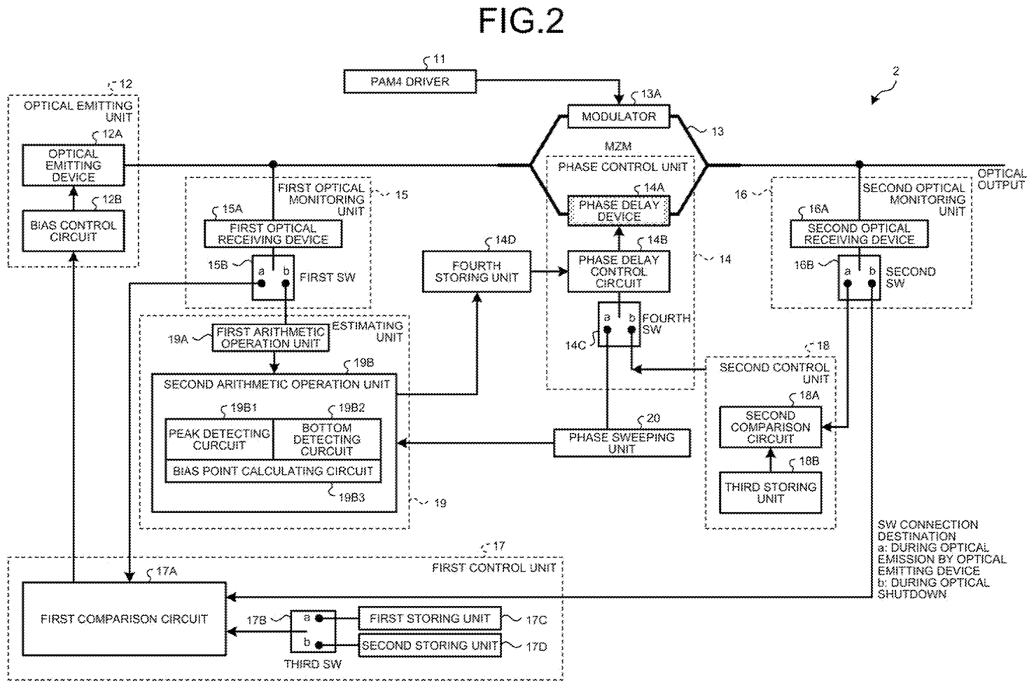

FIG. 2 is an explanatory diagram illustrating an exemplary configuration of the optical transmitter device 2. The optical transmitter device 2 illustrated in FIG. 2 includes the PAM4 driver 11, the optical emitting unit 12, the MZM 13, a phase control unit 14, a first optical monitoring unit 15, a second optical monitoring unit 16, a first control unit 17, a second control unit 18, an estimating unit 19, and a phase sweeping unit 20.

The optical emitting unit 12 includes an optical emitting device 12A and a bias control circuit 12B. The optical emitting device 12A uses, for example, a laser diode (LD), emits the optical signal having continuous waves (CW) according to the bias current, and varies the optical power of the optical signal according to the bias current amount. The bias control circuit 12B is a control circuit that supplies the bias current to the optical emitting device 12A. The bias control circuit 12B decides on the bias current to be supplied to the optical emitting device 12A based on setting current information received from the first control unit 17.

The MZM 13 includes the modulator 13A disposed on one of the arms, and includes a phase delay device 14A disposed on the other arm and inside the phase control unit 14. Moreover, the MZM 13 has signal electrodes disposed on the two arms and; when PMA3 signals are applied to the signal electrodes, an electrical field is generated in each arm and as a result the optical refractive index of the arm changes. The modulator 13A performs optical modulation of the optical signal, which is coming from the optical emitting device 12A, according to the PAM4 signals received from the PAM4 driver 11. The phase control unit 14 controls the phase delay device 14A that performs delay adjustment of the phase of the MZM 13. As a result, in the MZM 13, when PAM4 signals are applied to the electrodes on the arms that are parallel to each other, the optical refractive index of the arms changes and there occurs a phase difference in the optical signal that follow the arms. Then, the optical signal having a phase difference are multiplexed and optical-modulated signals are output.

The MZM 13 sets the optimum phase amount by varying its own transmission characteristics according the phase difference between the arms, and thus can output the optical-modulated signals in such a way that the optical power of the optical-modulated signals becomes the target value. The optimum phase amount of the MZM 13 is the midpoint of the peak value and the bottom value of the transmission characteristics. The transmission characteristics are, for example, the characteristics of phase-versus-transmittance that undergoes fluctuation due to temperature variation or temporal variation. Meanwhile, in order to obtain stable and optimum output waveforms of the optical signals, the phase delay device 14A needs to be set to have the phase delay amount that constantly retains the optimum phase amount (midpoint).

The phase control unit 14 includes the phase delay device 14A, a phase delay control circuit 14B, a fourth SW 14C, and a fourth storing unit 14D. The phase delay device 14A is, for example, a heater that varies the phase of the MZM 13 according to the phase delay amount. The phase delay control circuit 14B adjusts the phase delay amount to be set in the phase delay device 14A.

The fourth SW 14C enables changing the phase delay amount according to the operational state, so that the phase delay amount used for adjusting the phase delay device 14A is changed. During the operations, the fourth SW 14C sets the phase delay amount, which is received from the second control unit 18, in the phase delay control circuit 14B. Herein, the term “during the operations” implies the operational state in which the optical-modulated signals are stably output from the optical transmitter device 2. During the optical shutdown, the fourth SW 14C sets the phase delay amount, which is received from the phase sweeping unit 20, in the phase delay control circuit 14B. Herein, the term “during the optical shutdown” implies the state in which the output of the optical-modulated signals from the optical transmitter device 2 has dropped to be equal to or lower than a predetermined level. The fourth storing unit 14D is used to store the phase delay amount, which represents the phase delay amount initial value (explained later), to be set in the phase delay control circuit 14B at the time of cancelling the optical shutdown.

The first optical monitoring unit 15 includes a first optical receiving device 15A and a first switch 15B. The first optical monitoring unit 15 detects a first-type monitoring value representing the optical power of the optical signal passing through the input stage of the MZM 13. The first optical receiving device 15A converts the optical signal, which passes through the input stage of the MZM 13, into voltage; and detects the first-type monitoring value representing the optical power of the optical signal. During the operations, the first SW 15B sets the first-type monitoring value, which is detected by the first optical receiving device 15A, in a first comparison circuit 17A of the first control unit 17. Meanwhile, the first-type monitoring value detected during the operations is used in the optical emitting device APC of the first control unit 17 so that the optical power of the optical signal of the optical emitting device 12A becomes constant. During the optical shutdown, the first SW 15B sets the first-type monitoring value, which is detected by the first optical receiving device 15A, in a first arithmetic operation unit 19A of the estimating unit 19. Then, the first-type monitoring value detected during the optical shutdown is used by the estimating unit 19 at the time of estimating the transmission characteristics of the MZM 13.

The second optical monitoring unit 16 includes a second optical receiving device 16A and a second SW 16B. The second optical monitoring unit 16 detects a second-type monitoring value representing the optical power of the optical-modulated signals passing through the output stage of the MZM 13. The second optical receiving device 16A converts the optical-modulated signals, which pass through the output stage of the MZM 13, into voltage; and detects the second-type monitoring value representing the optical power of the optical-modulated signals. During the operations, the second SW 16B sets the second-type monitoring value, which is detected by the second optical receiving device 16A, in a second comparison circuit 18A of the second control unit 18. Then, the second-type monitoring value detected during the operations is used in the phase delay device APC of the second control unit 18 so that the optical power of the optical-modulated signals becomes constant. Moreover, during the optical shutdown, the second SW 16B sets the second-type monitoring value, which is detected by the second optical receiving device 16A, in the first comparison circuit 17A of the first control unit 17. Then, the second monitoring value detected during the optical shutdown is used in the first control unit 17 that controls the bias current of the optical signal in such a way that the second-type monitoring value becomes a second target value.

The first control unit 17 includes the first comparison circuit 17A, a third SW 17B, a first storing unit 17C, and a second storing unit 17D. The first control unit 17 controls the bias control circuit 12B of the optical emitting unit 12 during the operations. The third SW 17B sets a first target value, which is stored in the first storing unit 17C, in the first comparison circuit 17A during the operations. The first target value is meant for stabilizing the optical power of the optical signal. The third SW 17B sets the second target value, which is stored in the second storing unit 17D, in the first comparison circuit 17A during the optical shutdown. The second target value represents the level to which the optical power of the optical-modulated signals drops in the optical shutdown state.

The first comparison circuit 17A compares the first-type monitoring value and the first target value, which is stored in the first storing unit 17C, during the operations; and sets the bias current value in the bias control circuit 12B in such a way that the first-type monitoring value becomes the first target value. Meanwhile, the first target value conforms to the specifications of the optical power of the optical signal used during the operations. The first comparison circuit 17A functions as an optical emitting device APC for adjusting the bias current value meant for maintaining a constant optical power of the optical signal coming from the optical emitting device 12A, so that the first-type monitoring value and the first target value are identical to each other during the operations.

The first comparison circuit 17A compares the second-type monitoring value and the second target value, which is stored in the second storing unit 17D, during the optical shutdown; and sets the bias current value in the bias control circuit 12B in such a way that the second-type monitoring value becomes the second target value. The second target value conforms to the specifications of the optical power of the optical-modulated signals in the optical shutdown state. The first comparison circuit 17A functions as an optical emitting device APC for adjusting the bias current value for maintaining the optical power of the optical-modulated signals at the output stage of the MZM 13 at a constant level in the optical shutdown state, so that the second-type monitoring value and the second target value are identical to each other during the optical shutdown state.

The second control unit 18 includes a second comparison circuit 18A and a third storing unit 18B. The second control unit 18 controls the phase delay device 14A of the MZM 13 that stably outputs the second-type monitoring value during the operations. The second comparison circuit 18A compares the second-type monitoring value and a third target value, which is stored in the third storing unit 18B, and sets the phase delay amount in the phase delay control circuit 14B in such a way that the second-type monitoring value becomes the third target value. Thus, even when there is a fluctuation in the phase of the MZM 13 during the operations, since the optimum phase amount is set in such a way that the second-type monitoring value becomes the third target value, the second comparison circuit 18A functions as a phase delay device APC for adjusting the phase delay amount meant for retaining the optimum phase amount.

The phase delay control circuit 14B sets the phase delay amount initial value, which is stored in the fourth storing unit 14D, in the phase delay device 14A at the time of cancelling the optical shutdown. The phase delay amount initial value represents the phase delay amount of the phase delay device 14A used at the time of cancelling the optical shutdown. Meanwhile, the phase delay amount initial value represents the phase delay amount calculated from the estimated transmission characteristics of the MZM 13, and is updated during the optical shutdown.

The estimating unit 19 includes the first arithmetic operation unit 19A and a second arithmetic operation unit 19B. The estimating unit 19 operates only during the optical shutdown, and estimates the transmission characteristics of the MZM 13 based on the first-type monitoring value detected by the first optical monitoring unit 15 and based on the phase fluctuation information of the phase sweeping unit 20. Moreover, from the estimation result of the transmission characteristics of the MZM 13, the estimating unit 19 calculates the phase delay amount initial value at the time of cancelling the optical shutdown.

During the optical shutdown, while the phase sweeping unit 20 performs phase sweeping, the first arithmetic operation unit 19A obtains the first-type monitoring value, which is detected by the first optical monitoring unit 15. The first arithmetic operation unit 19A performs an arithmetic operation of the reciprocal of the first-type monitoring value and phase sweeping information received from the phase sweeping unit 20, and estimates the transmission characteristics of the MZM 13 for the reciprocal-versus-phase of the first-type monitoring value. The reciprocal of the first-type monitoring value is the characteristic indicating the relationship between the reciprocal of the optical power of the optical signal and the time. The phase sweeping information indicates the relationship between the phase and the time indicating the temporal transition of the phase in a constant period in the phase sweeping unit 20.

The second arithmetic operation unit 19B calculates, as the phase delay amount initial value, the phase delay amount equivalent to the midpoint (the optimum phase amount) from the estimation result of the transmission characteristics of the MZM 13. The second arithmetic operation unit 19B includes a peak detecting circuit 19B1, a bottom detecting circuit 19B2, and a bias point calculating circuit 19B3. The peak detecting circuit 19B1 detects the peak value from the estimation result of the transmission characteristics of the MZM 13 as received from the first arithmetic operation unit 19A. The bottom detecting circuit 19B2 detects the bottom value from the estimation result of the transmission characteristics of the MZM 13 as received from the first arithmetic operation unit 19A. The bias point calculating circuit 19B3 calculates the phase delay amount equivalent to the optimum phase amount of the MZM 13 representing the midpoint of the detected peak value and the detected bottom value. The bias point calculating circuit 19B3 stores the calculated phase delay amount as the phase delay amount initial value in the fourth storing unit 14D.

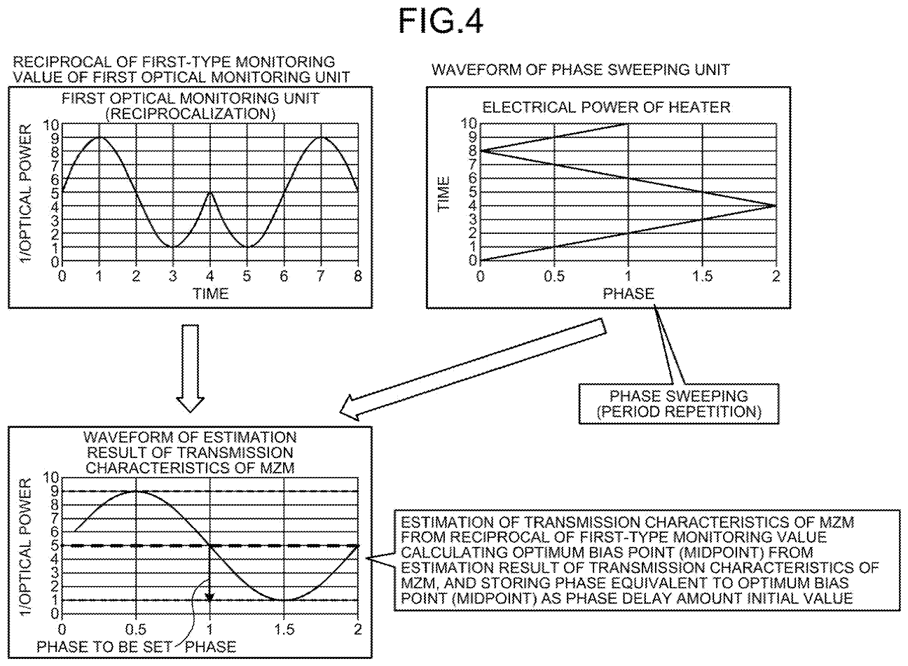

The phase sweeping unit 20 sets, in the phase delay control circuit 14B, the phase delay amount meant for performing constant-period sweeping of the phase within a constant period of the MZM 13 during the optical shutdown. Meanwhile, the phase to be subjected to sweeping is equal to or greater than π, and the waveform is as illustrated in FIG. 4. The phase sweeping unit 20 sweeps the phase of a constant period of the MZM 13, that is, sweeps the transmittance of the MZM 13 from 0% (0) to 100% (1).

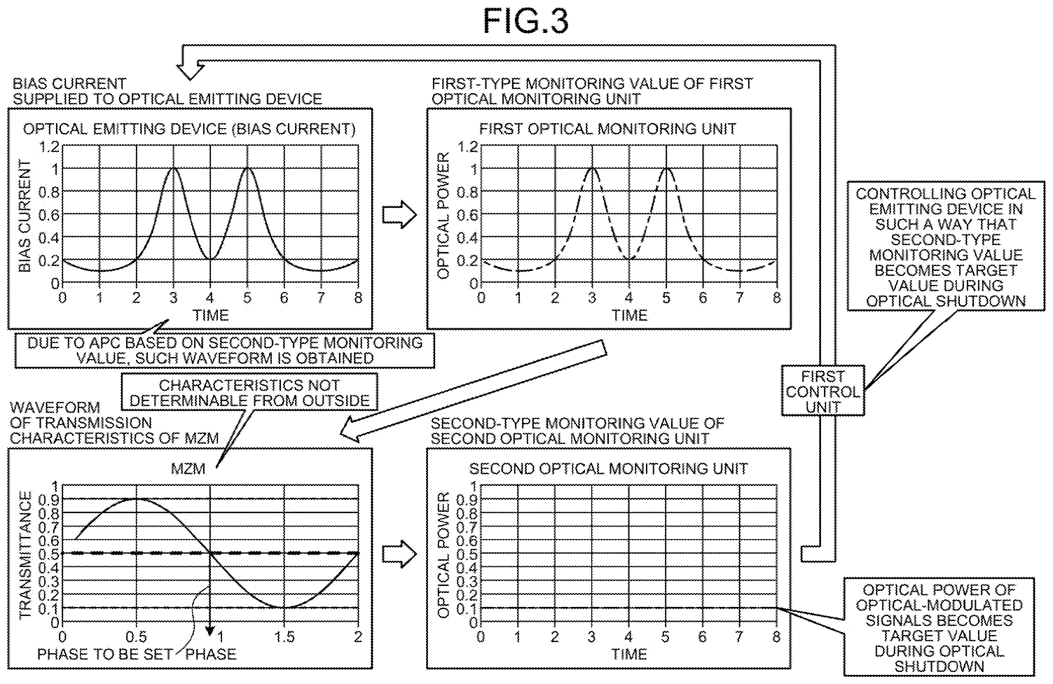

FIG. 3 is an explanatory diagram illustrating an example of the bias current control based on the second-type monitoring value in the optical shutdown state. The first optical monitoring unit 15 obtains the first-type monitoring value representing the optical power of the optical signal at the input stage of the MZM 13 in the optical shutdown state. The second optical monitoring unit 16 obtains the second-type monitoring value representing the optical power of the optical-modulated signals at the output stage of the MZM 13 in the optical shutdown state. The transmission characteristics of the MZM 13 are as illustrated in FIG. 3. However, in the optical transmitter device 2, the transmission characteristics of the MZM 13 cannot be measured. The first control unit 17 controls the optical power of the optical signal of the optical emitting device 12A in such a way that the second-type monitoring value becomes the target value (the second target value) in the optical shutdown state.

FIG. 4 is an explanatory diagram illustrating an example of the estimation operation for estimating the transmission characteristics of the MZM 13 in the optical shutdown state. During the optical shutdown, the phase sweeping unit 20 sequentially sets, in the phase delay control circuit 14B, the phase delay amount for performing constant-period sweeping of the phase of the MZM 13. Moreover, the first optical monitoring unit 15 detects the first-type monitoring value during the phase sweeping, and outputs it to the estimating unit 19. The estimating unit 19 estimates the transmission characteristics of the MZM 13 based on the reciprocal of the first-type monitoring value, which is detected by the first optical monitoring unit 15 during the phase sweeping, and based on the phase transition of the constant period as performed by the phase sweeping unit 20. The estimating unit 19 detects the peak value and the bottom value from the estimation result of the transmission characteristics of the MZM 13, and calculates the midpoint (the optimum phase amount: a dotted line) of the peak value and the bottom value. Moreover, the estimating unit 19 stores, as the phase delay amount initial value in the fourth storing unit 14D, the phase delay amount corresponding to the calculated optimum phase amount. As a result, when the cancellation of the optical shutdown is detected, the second control unit 18 sets the phase delay amount initial value in the phase delay control circuit 14B and starts the control of the phase delay device APC. Since the start of the control is from the phase delay amount initial value; unlike in the second comparison example, there is no need to secure the time period Ts starting from the cancellation of the optical shutdown to the time when the optical power of the optical-modulated signals reaches the target value. Hence, the period of time starting from the cancellation of the optical shutdown to the output of the optical-modulated signals can conform to the specification criteria.

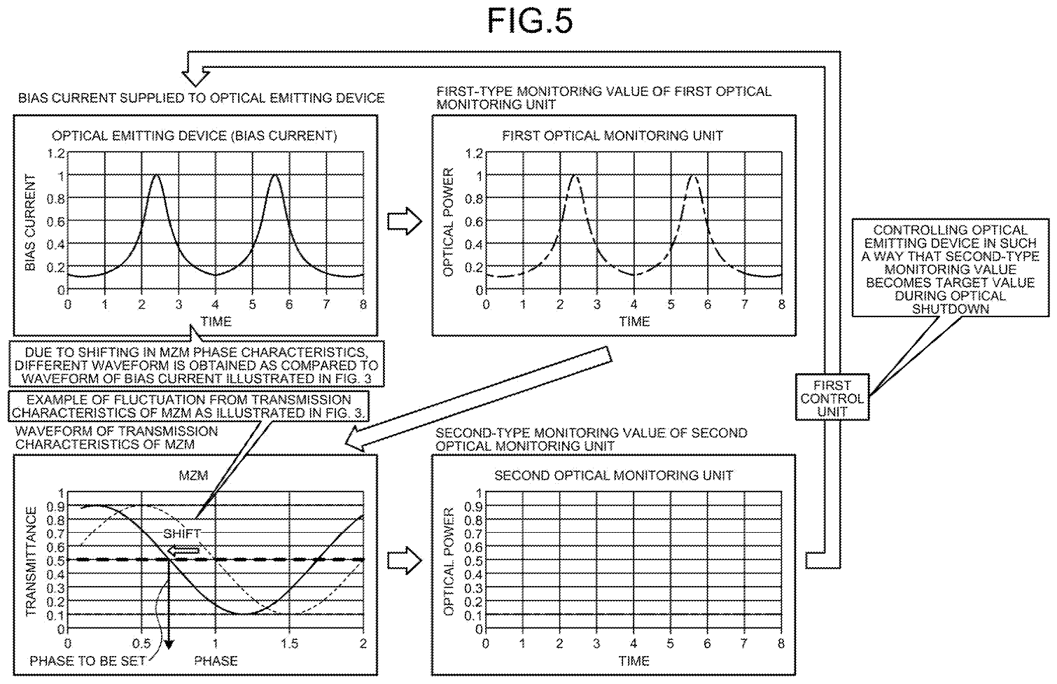

FIG. 5 is an explanatory diagram illustrating an example of the bias current control based on the second-type monitoring value at the time of phase fluctuation in the optical shutdown state. In the optical shutdown state too, the phase of the MZM 13 fluctuates due to temporal variation or temperature variation. In the transmission characteristics of the MZM 13 as illustrated in FIG. 5, the transmission characteristics change from the pre-phase-fluctuation transmission characteristics (a dotted line) to the post-phase-fluctuation transmission characteristics (a solid line). As explained earlier, in the optical transmitter device 2, the transmission characteristics of the MZM 13 cannot be measured. Even after the phase fluctuation occurs, the first control unit 17 controls the signal power of the optical emitting device 12A in such a way that the second-type monitoring value becomes the target value (the second target value) in the optical shutdown state.

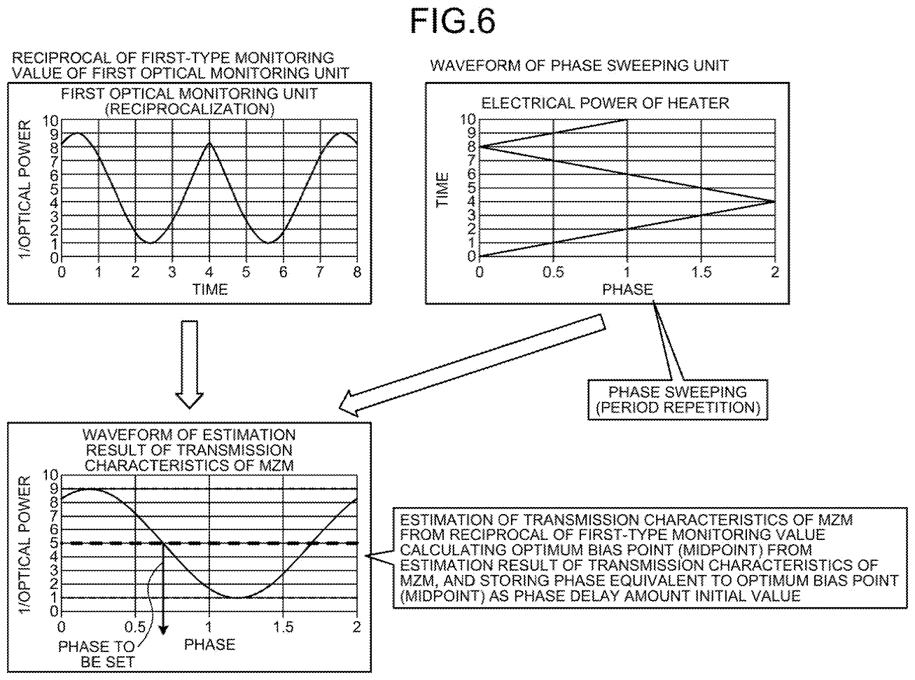

FIG. 6 is an explanatory diagram illustrating an example of the estimation operation for estimating the transmission characteristics of the MZM 13 at the time of phase fluctuation in the optical shutdown state. During the optical shutdown, the phase sweeping unit 20 sequentially sets, in the phase delay control circuit 14B, the phase delay amount for performing constant-period sweeping of the phase of the MZM 13. Moreover, the first optical monitoring unit 15 detects the first-type monitoring value during the phase sweeping, and outputs the first-type monitoring value, which is detected during the phase sweeping, to the estimating unit 19. The estimating unit 19 estimates the transmission characteristics of the MZM 13 based on the reciprocal of the first-type monitoring value, which is detected by the first optical monitoring unit 15 during the phase sweeping, and based on the phase transition of the constant period as performed by the phase sweeping unit 20. Then, the estimating unit 19 detects the peak value and the bottom value from the estimation result of the transmission characteristics of the MZM 13, and calculates the midpoint (the optimum phase amount: a dotted line) of the peak value and the bottom value. Subsequently, the estimating unit 19 stores, as the phase delay amount initial value in the fourth storing unit 14D, the phase delay amount corresponding to the calculated optimum phase amount. As a result, when the cancellation of the optical shutdown is detected, the second control unit 18 sets the phase delay amount initial value in the phase delay control circuit 14B, and starts the control of the phase delay device APC. Since the start of the control is from the phase delay amount initial value; unlike in the second comparison example, there is no need to secure the time period Ts starting from the cancellation of the optical shutdown to the time when the optical power of the optical-modulated signals reaches the target value. Hence, even if phase fluctuation occurs during the optical shutdown, the period of time starting from the cancellation of the optical shutdown to the output of the optical-modulated signals can conform to the specification criteria.

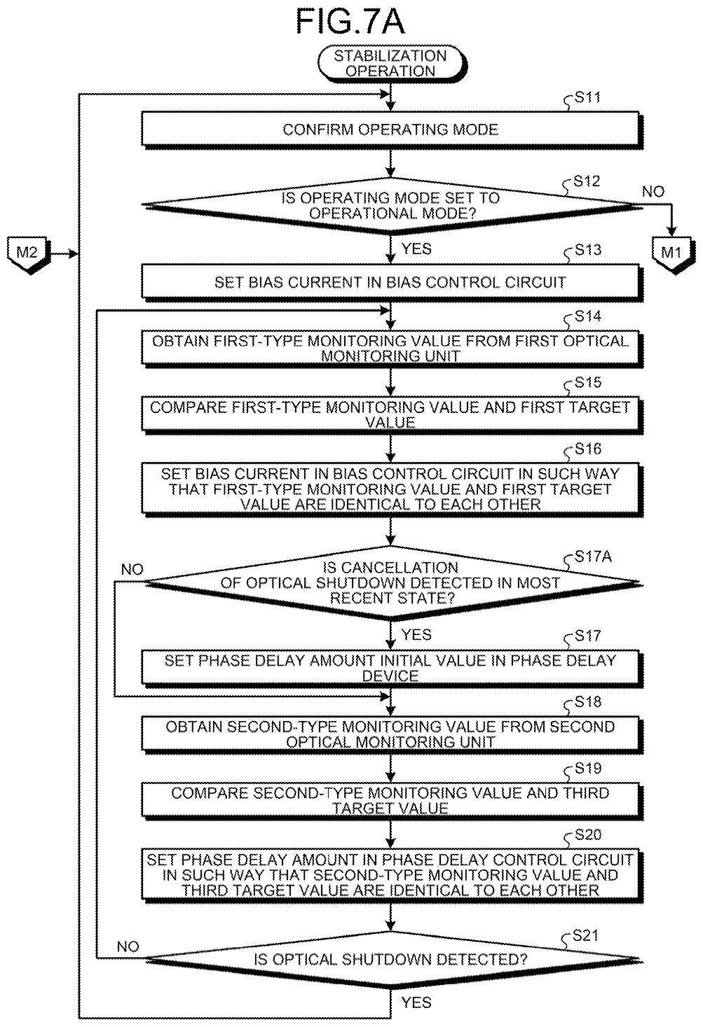

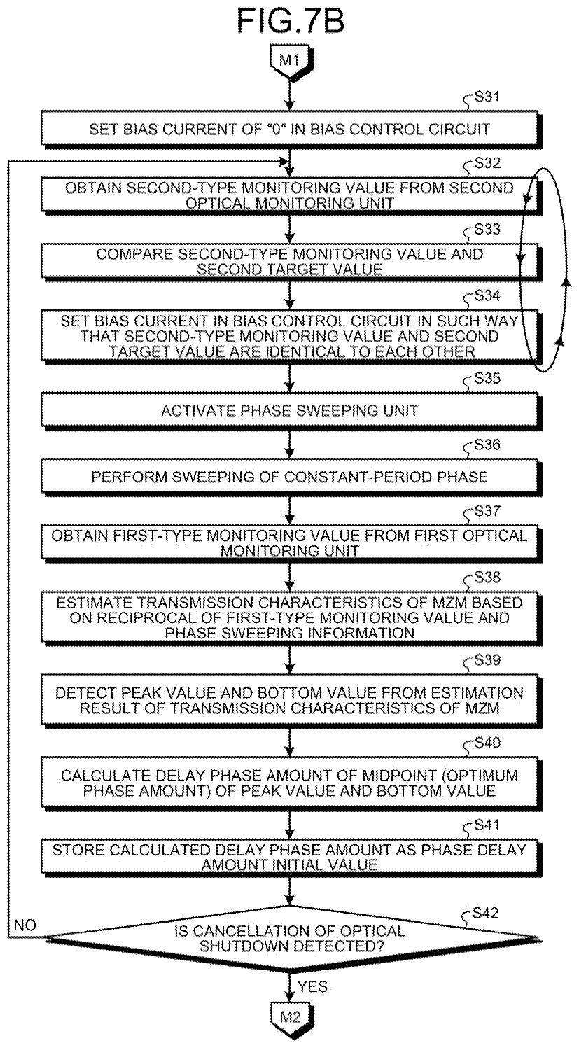

Given below is the explanation of the operations performed by the optical transmitter device 2 according to the embodiment. FIGS. 7A and 7B are flowcharts for explaining an example of the operations performed by the optical transmitter device 2 for stabilization. The optical transmitter device 2 confirms the operating mode (Step S11). The operating mode can either be set to an operational mode indicating the operational state in which the optical power of the optical-modulated signals, which is the output of the optical transmitter device 2, is output in a stable manner; or can be set to an optical shutdown mode in which the optical power of the optical-modulated signals, which is the output of the optical transmitter device 2, is at the level of the optical shutdown state. The optical transmitter device 2 determines whether or not the operating mode is set to the operational mode (Step S12).

If the operating mode is set to the operational mode (Yes at Step S12), then the optical transmitter device 2 sets the bias current in the bias control circuit 12B (Step S13). The first control unit 17 of the optical transmitter device 2 obtains, from the first optical monitoring unit 15, the first-type monitoring value representing the optical power of the optical signal passing through the input stage of the MZM 13 (Step S14). Then, the first comparison circuit 17A of the first control unit 17 compares the first-type monitoring value and the first target value (Step S15), and sets the bias current in the bias control circuit 12B in such a way that the first-type monitoring value and the first target value are identical to each other (Step S16).

After the bias current is set in such a way that the first-type monitoring value and the first target value are identical to each other, the phase delay control circuit 14B of the optical transmitter device 2 determines whether or not the cancellation of the optical shutdown is detected in the most recent state (Step S17A). If the cancellation of the optical shutdown is detected in the most recent state (Yes at Step S17A), then the phase delay control circuit 14B sets the phase delay amount initial value, which is stored in the fourth storing unit 14D, in the phase delay device 14A (Step S17). The second control unit 18 of the optical transmitter device 2 obtains, from the second optical monitoring unit 16, the second-type monitoring value representing the optical power of the optical-modulated signals passing through the output stage of the MZM 13 (Step S18).

The second comparison circuit 18A of the second control unit 18 compares the second-type monitoring value and the third target value (Step S19), and sets the phase delay amount in the phase delay control circuit 14B in such a way that the second-type monitoring value and the third target value are identical to each other (Step S20). After the phase delay amount is set in the phase delay control circuit 14B in such a way that the second-type monitoring value and the third target value are identical to each other, the optical transmitter device 2 determines whether or not the optical shutdown is detected (Step S21).

If the optical shutdown is not detected (No at Step S21), then the optical transmitter device 2 determines that the operating mode is currently set to the operational mode, and the system control returns to Step S14 for obtaining the first-type monitoring value from the first optical monitoring unit 15. On the other hand, if the optical shutdown is detected (Yes at Step S21), then the system control returns to Step S11 for confirming the current operating mode.

If the operating mode is not currently set to the operational mode (No at Step S12), then the system control proceeds to M1 illustrated in FIG. 7B. Moreover, if the cancellation of the optical shutdown is not detected in the most recent state (No at Step S17A), then the second control unit 18 determines that the operations are still going on. Then, the system control returns to Step S18 at which the second control unit 18 obtains, from the second optical monitoring unit 16, the second-type monitoring value representing the optical power of the optical-modulated signals passing through the output stage of the MZM 13.

In M1 illustrated in FIG. 7B, if it is determined that the operating mode is currently set to the optical shutdown mode, then the optical transmitter device 2 sets the bias current of “0” in the bias control circuit 12B (Step S31). Then, as illustrated in FIG. 3, the first control unit 17 of the optical transmitter device 2 obtains, from the second optical monitoring unit 16, the second-type monitoring value representing the optical power of the optical-modulated signals passing through the output stage of the MZM 13 in the optical shutdown state (Step S32).

The first comparison circuit 17A of the first control unit 17 compares the second-type monitoring value and the second target value (Step S33), and sets the bias current in the bias control circuit 12B in such a way that the second-type monitoring value and the second target value are identical to each other (Step S34). Meanwhile, it is assumed that the operations at Steps S32, S33, and S34 are performed on a continuing basis.

After the bias current is set in such a way that the second-type monitoring value and the second target value are identical to each other, the phase sweeping unit 20 gets activated (Step S35) and performs constant-period sweeping of the phase of the MZM 13 (Step S36).

As illustrated in FIG. 4, during the phase sweeping in a constant period, the estimating unit 19 of the optical transmitter device 2 obtains, from the first optical monitoring unit 15, the first-type monitoring value representing the optical power of the optical signal passing through the input stage of the MZM 13 (Step S37). Meanwhile, when the phase sweeping at Step S36 is performed while performing the operations at Steps S32, S33, and S34 on a continuing basis, the features of the bias current, which is supplied to the optical emitting device 12A illustrated in FIG. 3, and the time can be obtained and thus the first-type monitoring value can be obtained. Then, the first arithmetic operation unit 19A of the estimating unit 19 estimates the transmission characteristics of the MZM 13 based on the reciprocal of the first-type monitoring value obtained during the phase sweeping and based on the phase sweeping information (Step S38).

The second arithmetic operation unit 19B of the estimating unit 19 detects the peak value and the bottom value from the estimation result of the transmission characteristics of the MZM 13 (Step S39). The second arithmetic operation unit 19B calculates the phase delay amount equivalent to the midpoint (the optimum phase amount) of the detected peak value and the detected bottom value) (Step S40), and stores the calculated phase delay amount as the phase delay amount initial value in the fourth storing unit 14D (Step S41).

Moreover, the optical transmitter device 2 determines whether or not the cancellation of the optical shutdown of the optical emitting device 12A is detected (Step S42). If the cancellation of the optical shutdown is detected (Yes at Step S42), then the system control proceeds returns to Step S11 for confirming the operating mode as illustrated in FIG. 7A. On the other hand, if the cancellation of the optical shutdown is not detected (No at Step S42), then the system control returns to Step S32 for obtaining, from the second optical monitoring unit 16, the second-type monitoring value of the optical-modulated signals at the output stage of the MZM 13.

The phase sweeping unit 20 sequentially sets, in the phase delay control circuit 14B, the phase delay amount for performing constant-period sweeping of the phase of the MZM 13 during the optical shutdown. Moreover, the first optical monitoring unit 15 detects the first-type monitoring value during the phase sweeping; and outputs the first-type monitoring value, which is detected during the phase sweeping, to the estimating unit 19. The estimating unit 19 estimates the transmission characteristics of the MZM 13 based on the reciprocal of the first-type monitoring value obtained by the first optical monitoring unit 15, and based on the phase transition performed by the phase sweeping for the constant period. Then, the estimating unit 19 detects the peak value and the bottom value from the estimation result of the transmission characteristics of the MZM 13; calculates the midpoint (the optimum phase amount: a dotted line) of the peak value and the bottom value; and stores the phase delay amount corresponding to the optimum phase amount as the phase delay amount initial value in the fourth storing unit 14D. If the cancellation of the optical shutdown is detected, then the second control unit 18 sets the phase delay amount initial value in the phase delay control circuit 14B and starts the control of the phase delay device APC. Since the control is started from the phase delay amount initial value; unlike in the second comparison example, there is no need to secure the time period Ts starting from the cancellation of the optical shutdown to the time when the optical power of the optical-modulated signals reaches the target value. Hence, the period of time starting from the cancellation of the optical shutdown to the output of the optical-modulated signals can conform to the specification criteria.

The optical transmitter device 2 according to the embodiment detects the second-type monitoring value during the optical shutdown, and controls the bias current of the optical emitting unit 12 in such a way that the second monitoring value becomes the target value during the optical shutdown (the second target value). After the bias current of the optical emitting unit 12 is controlled, the optical transmitter device 2 detects the first-type monitoring value while performing constant-period sweeping of the phase of the MZM 13, and estimates the transmission characteristics of the MZM 13 from the first-type monitoring value. Moreover, the optical transmitter device 2 calculates the optimum phase amount, which is to be set in the phase control unit 14, from the estimation result of the transmission characteristics of the MZM 13, and stores the phase delay amount equivalent to the optimum phase amount as the phase delay amount initial value in the fourth storing unit 14D. If the cancellation of the optical shutdown is detected, then the second control unit 18 sets the phase delay amount initial value in the phase delay control circuit 14B and starts the control of the phase delay device APC. Since the control is started from the phase delay amount initial value; unlike in the second comparison example, there is no need to secure the time period Ts starting from the cancellation of the optical shutdown to the time when the optical power of the optical-modulated signals reaches the target value. Hence, the period of time starting from the cancellation of the optical shutdown to the output of the optical-modulated signals can conform to the specification criteria. Besides, since the dither signals are not used, it becomes possible to hold down any deterioration in the signal quality of the main signals.

If the cancellation of the optical shutdown is detected, then the optical transmitter device 2 sets, in the phase delay control circuit 14B, the phase delay amount equivalent to the phase delay amount initial value calculated by the estimating unit 19. Moreover, after the phase delay amount equivalent to the phase delay amount initial value is set in the phase delay control circuit 14B, the optical transmitter device 2 starts the control of the phase control unit 14 in such a way that the second-type monitoring value becomes the target value during the operations (the third target value). Hence, the period of time starting from the cancellation of the optical shutdown to the output of the optical-modulated signals can conform to the specification criteria.

The optical transmitter device 2 estimates the transmission characteristics of the MZM 13 based on the reciprocal of the first-type monitoring value of the first optical monitoring unit 15 and based on the phase information of the constant-period sweeping of the MZM 13. As a result, the optical transmitter device 2 can estimate the transmission characteristics of the MZM 13.

The optical transmitter device 2 detects the peak value and the bottom value from the estimation result of the transmission characteristics of the MZM 13 and calculates, as the phase delay amount initial value, the phase delay amount equivalent to the midpoint of the peak value and the bottom value (i.e., the optimum phase amount). As a result, it becomes possible to calculate the phase delay amount initial value equivalent to the optimum phase amount to be used in cancelling the optical shutdown.

The optical transmitter device 2 modulates the optical signal using multivalued electrical signals (PAM4 signals) as electrical signals, and outputs the optical-modulated signals. As a result, it becomes possible to hold down any deterioration in the signal quality of the PAM4 signals in the main signals. As pointed out in the conventional technology, when the dither signals are used, in the case of multivalued modulation signals such as PAM4 signals, multivalued signals happen to be present in the same optical level as compared to the NRZ of binary modulation. Hence, the power difference among the optical levels is small, and the effect of the dither signals becomes large particularly in the level 1 and the level 2. In contrast, in the embodiment, since the dither signals are not used, even if multivalued modulation signals such as PAM4 signals are present, it becomes possible to secure the power difference between the level 1 and the level 2 from among the level 0 to the level 3, thereby enabling holding down any deterioration in the signal quality.

In the optical transmitter device 2, since the dither signals are not used in setting the optimum phase amount of the MZM 13, it becomes possible to hold down any deterioration in the transmission quality of the main signals. Moreover, in the optical transmitter device 2, because of the control for maintaining the optimum phase amount of the MZM 13 even during the optical shutdown, it becomes possible to hold down any waveform deterioration at the time of cancelling the optical shutdown.

Moreover, the optical transmitter device 2 varies the bias current in such a way that, during the optical shutdown, the optical-modulated signals at the output stage of the MZM 13 become constant. Consequently, the bias changing point becomes large, and it becomes possible to enhance the accuracy. Moreover, in the optical transmitter device 2, since there is no need to use an optical shutter (a optical blocking unit), the configuration becomes simpler and the system configuration can be achieved at low cost.

Meanwhile, in the optical transmission device 1 according to the embodiment, the optical transmitter devices of the four-wavelength-multiplexing type are illustrated. Alternatively, it is also possible to implement the embodiment in an optical reception device of the four-wavelength-multiplexing type. Moreover, in the optical transmission device 1 according to the embodiment, although the four-wavelength-multiplexing method is implemented, that is not the only possible case. That is, as long as it is possible to perform multiplexing of a plurality of wavelengths, the number of wavelengths can be appropriately changed.

Moreover, for the purpose of illustration, the phase delay device 14A is used as the phase control unit 14. However, as long as the function is provided for adjusting the phase of the optical signals of the two arms in the MZM 13, it serves the purpose.

Furthermore, the explanation is given for the case in which the phase delay amount of the phase delay device 14A is adjusted and the phase of the optical signals passing through the two arms is adjusted. However, that is not the only possible case. Alternatively, the phase of the transmission spectrum of a optical multiplexing unit at the output stage of the MZM 13 can be adjusted.

The constituent elements of the device illustrated in the drawings need not be physically configured as illustrated. The constituent elements, as a whole or in part, can be separated or integrated either functionally or physically based on various types of loads or use conditions.

Moreover, some or all of the processing functions implemented in each device can be executed using a central processing unit (CPU) (or a micro processing unit (MPU)) or a microcomputer such as a micro controller unit (MCU). Furthermore, it goes without saying that some or all of the processing functions can be executed using computer programs that are analyzed and executed in a CPU (or an MPU, or in a microcomputer such as an MCU), or using hardware with wired logic.

According to an aspect, it becomes possible to retain the optimum phase amount, and to hold down any deterioration in the transmission quality of the main signals.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical transmitter device comprising:
an optical emitter that emits an optical signal according to bias current;
an optical modulator of Mach-Zehnder type that modulates the optical signal using an electrical signal and outputs an optical-modulated signal;
a first optical monitor that detects power of the optical signal at input stage of the optical modulator;
a second optical monitor that detects power of the optical modulated signal at output stage of the optical modulator;
a phase controller that controls phase difference of the optical modulator according to a setting phase amount;
a controller that
during optical shutdown of the optical transmitter device, detects power of the optical modulated signal using the second optical monitor, and
controls bias current of the optical emitter in such a way that detection result obtained by the second optical monitor becomes target value during optical shutdown;
a phase sweeper that, after bias current of the optical emitter is controlled by the controller, performs constant-period sweeping of phase of the optical modulator; and
an estimator that
detects power of the optical signal using the first optical monitor while performing constant-period sweeping of phase of the optical modulator,
from detection result obtained by the first optical monitor, estimates transmission characteristic of the optical modulator, and
from estimation result of the transmission characteristic, calculates optimum phase amount to be set in the phase controller.

2. The optical transmitter device according to claim 1, wherein, when cancellation of the optical shutdown is detected, the controller sets the optimum phase amount, which is calculated by the estimator, in the phase controller and starts control of the phase controller in such a way that detection result obtained by the second optical monitor becomes target value during operations.

3. The optical transmitter device according to claim 1, wherein the estimator estimates transmission characteristic of the optical modulator based on reciprocal of detection result obtained by the first optical monitor and based on phase information of constant-period sweeping of the optical modulator.

4. The optical transmitter device according to claim 3, wherein the estimator
detects peak value and bottom value from transmission characteristic of the optical modulator, and
calculates the optimum phase amount corresponding to midpoint of the peak value and the bottom value.

5. The optical transmitter device according to claim 1, wherein the controller
retains phase amount for controlling phase difference of the phase controller in such a way that, during operations, detection result obtained by the second optical monitor becomes target value during the operations, and
during the optical shutdown, retains the optimum phase amount calculated by the estimator.

6. The optical transmitter device according to claim 1, wherein the optical modulator modulates the optical signal using multivalued electrical signal as the electrical signal, and outputs the optical-modulated signal.

7. An optical transmission device comprising:
a plurality of optical transmitter devices; and
an optical multiplexer that multiplexes optical-modulated signal coming from each of the optical transmitter devices, wherein
each of the optical transmitter devices includes
an optical emitter that emits an optical signal according to bias current,
an optical modulator of Mach-Zehnder type that modulates the optical signal using an electrical signal and outputs an optical-modulated signal,
a first optical monitor that detects power of the optical signal at input stage of the optical modulator,
a second optical monitor that detects power of the optical-modulated signal at output stage of the optical modulator,
a phase controller that controls phase difference of the optical modulator according to a setting phase amount,
a controller that
during optical shutdown of the optical transmitter device, detects power of the optical-modulated signal using the second optical monitor, and
controls bias current of the optical emitter in such a way that detection result obtained by the second optical monitor becomes target value during optical shutdown,
a phase sweeper that, after bias current of the optical emitter is controlled by the controller, performs constant-period sweeping of phase of the optical modulator, and
an estimator that
detects power of the optical signal using the first optical monitor while performing constant-period sweeping of phase of the optical modulator,
from detection result obtained by the first optical monitor, estimates transmission characteristic of the optical modulator, and
from estimation result of the transmission characteristic, calculates optimum phase amount to be set in the phase controller.

8. An optimum-phase-amount calculation method implemented in an optical transmitter device that includes
an optical emitter that emits an optical signal according to bias current,
an optical modulator of Mach-Zehnder type that modulates the optical signal using an electrical signal and outputs an optical-modulated signal,
a first optical monitor that detects power of the optical signal at input stage of the optical modulator,
a second optical monitor that detects power of the optical-modulated signal at output stage of the optical modulator, and
a phase controller that controls phase difference of the optical modulator according to a setting phase amount,
the optimum-phase-amount calculation method comprising:
detecting, during optical shutdown of the optical transmitter device, power of the optical-modulated signal using the second optical monitor, and
controlling bias current of the optical emitter in such a way that detection result obtained by the second optical monitor becomes target value during optical shutdown;
performing, after bias current of the optical emitter is controlled, constant-period sweeping of phase of the optical modulator; and
detecting power of the optical signal using the first optical monitor while performing constant-period sweeping of phase of the optical modulator,
estimating, from detection result obtained by the first optical monitor transmission characteristic of the optical modulator, and
calculating, from estimation result of the transmission characteristic, optimum phase amount to be set in the phase controller.
